(19) United States
(12) Patent Application Publication
(10) Pub. No.: US 2025/0354378 A1
(43) Pub. Date: Nov. 20, 2025

(54) SYSTEM AND APPARATUS FOR INCORPORATING SOUND ABSORPTION INTO CROSS LAMINATED TIMBER (CLT)

(71) Applicant: Arup IP Management Ltd., London (GB)

(72) Inventors: Ben Loshin, Auburn, WA (US); Denis Blount, Seattle, WA (US); Alban Basuet, Warwick, RI (US)

(73) Assignee: Arup IP Management Ltd., London (GB)

(21) Appl. No.: 19/209,830

(22) Filed: May 16, 2025

Related U.S. Application Data
(60) Provisional application No. 63/648,203, filed on May 16, 2024.

(51) Int. Cl. E04C 2/296; B32B 3/14; B32B 3/18; B32B 3/30; B32B 7/03; B32B 21/13

(52) U.S. Cl. CPC E04C 2/296; B32B 3/14; B32B 3/18; B32B 3/30; B32B 7/03; B32B 21/13; B32B 2307/102; B32B 2307/3065; B32B 2471/00

(57) ABSTRACT

The present invention introduces a novel approach to sound absorption in cross-laminated timber (CLT) panels by integrating acoustic absorption into the bottom ply. This eliminates the need for external sound absorbing finishes which are costly and obscure the exposed wood aesthetic. Comprised of channels filled with sound-absorbing material, the absorbers target a broad range of frequencies relevant to architectural applications. This feature is incorporated within the standard CLT lay-up and glueing process. By strategically removing material where it minimally affects panel strength, the CLT panels maintain robustness as a structural member, enhancing room acoustics while preserving the natural wood aesthetics and structural qualities of CLT. In architectural and construction contexts, this integration of acoustic absorption offers a practical and efficient solution to a known limitation of mass timber construction.

### CROSS-REFERENCE TO RELATED APPLICATIONS

This application is a U.S. Non-Provisional Utility Patent Application which claims priority to U.S. Provisional Patent Application No. 63/648,203, filed on May 16, 2024, the contents of which are hereby fully incorporated by reference.

### FIELD

This invention relates to integrating sound absorption features within Cross-Laminated Timber (CLT) panels, particularly in the context of floor slabs.

### BACKGROUND

While sound isolation strategies have been explored, attention to sound absorption remains limited within mass timber buildings. For instance, one approach involves integrating acoustic topping layers onto mass timber floor slabs to achieve sound isolation between floors in a building. Acoustic toppings and prefab timber panels with integrated insulation offer both thermal benefits and claimed sound isolation, but do not address sound absorption properties. Some known building systems include weather and impact-resistant packaging materials for structural timber elements configured for providing fire protection and sound absorption properties. For example, it is currently known for attaching sound-absorbing layers to wood construction systems, such as filling voids in timber floor panels with sound absorption materials. Advancements in composite materials and timber panels with integrated sound-dampening mechanisms further contribute to improving sound absorption in mass timber structures. However, there is still a long felt, yet unfulfilled need for sound absorption properties to be enhanced from integration of sound absorbing material into mass timber structural elements.

Sound absorption techniques in mass timber are not a primary focus in mass timber buildings, as many techniques are rather implemented for integrating sound isolating materials within panel assemblies to address sound separation between occupied spaces. However, these techniques often conceal the absorption layer within the structure, limiting its exposure to the room and its effectiveness in controlling room acoustics. Some solutions, like those offered by Lignotrend, provide highly customized kits but do not leverage standard mass timber elements like CLT, require sole sourcing, and have not been widely adopted by the mass timber industry. Additionally, certain approaches emphasize fire resistance or impact sound insulation rather than room acoustic sound absorption. Overall, these techniques focus on sound isolation rather than room acoustic sound absorption and require divergence from standard mass timber construction practices. However, none of these approaches have provided a comprehensive solution that combines the features described in this disclosure.

### SUMMARY

A system and apparatus to embed sound absorption functionality within Cross-Laminated Timber (CLT) panels is described. This entails integrating sound absorption directly into CLT floor or wall slabs, allowing the aesthetic timber surface to remain visible while retaining structural integrity and offering sound absorption capabilities in the plane of the exposed CLT. This innovation is poised to enhance the attractiveness and feasibility of mass timber as a preferred structural solution across diverse projects. The value proposition and potential benefits of incorporating integrated sound absorption features into mass timber construction projects are described herein. In particular, there is an importance of using renewable resources like timber to reduce the carbon footprint in the built environment and there is a growing imperative to construct more buildings using renewable resources like timber. By integrating sound absorption features, a greater portion of the timber can be left exposed, thereby improving the value and feasibility of mass timber as a structural design option across a spectrum of commercial projects, encompassing education, commercial offices, and arts and culture spaces.

The process involves a modification to a standard CLT panel, regardless of its ply count or thickness. This modification includes machining channels along the short face of each lamella that comprises the bottom ply, running parallel to the grain axis for the entire length of the board. When assembled, these channels form rectangular chambers through the mating of mirror image slots in adjacent boards. Additionally, the edges of each board are notched or chamfered at visible corners, creating periodic visible slots when boards are joined. These visible slots are strategically designed in terms of length, frequency, and orientation to optimize both acoustic performance and aesthetics. Chamfering the slots enlarges the “effective opening,” enhancing high-frequency performance. The chambers are then filled with strips of sound-absorbing, fire-resistant material, such as mineral wool. The boards are subsequently glued, laid up, and pressed according to standard CLT processing methods. The spaces between the visible slots allow for lateral contact and glue joints between adjacent boards. These chambers and slots act as acoustic resonators, with their performance further improved by the inclusion of sound-absorbing material. The resonators are geometrically “tuned” to target specific resonant frequencies, forming a tuned resonator array during the standard assembly process of individual boards. The geometric parameters of this array can be optimized to provide sound absorption across a range of frequencies relevant to architectural acoustics and can be adjusted on a project-specific basis. Importantly, this modification aims to minimally impact the strength and stiffness of the CLT panel in its primary spanning direction, wherein the bottom ply experiences longitudinal loading. Shear strength is maintained by the horizontal glue joint at the top of the bottom ply and in the secondary spanning direction by the vertical edge glue joints between lamellae.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a cross-sectional view of an example of a bottom ply of a CLT panel for use in a floor slab with one or more channels at the bottom ply in accordance with some embodiments.

FIG. 2 is a cross-sectional view of an example of a CLT panel for use in a floor slab with one or more channels at the bottom ply of FIG. 1 in accordance with some embodiments.

FIG. 3 is a partial rear view of an example of the CLT panel of FIG. 2 in accordance with some embodiments.

FIGS. 4-6 are perspective views of an example of a CLT panel for use in a floor slab that implements a slat design in accordance with some embodiments.

FIGS. 7-9 illustrate another example CLT panel for use in a floor slab that implements a notched lamella design in accordance with some embodiments.

FIGS. 10-12 illustrate another example CLT panel for use in a floor slab that implements a perforated lamella design in accordance with some embodiments.

FIGS. 13 and 14 illustrate another example CLT panel for use in a floor slab that implements an every other lamella design in accordance with some embodiments.

FIGS. 15 and 16 illustrate another example CLT panel for use in a floor slab that implements a perforated veneer in accordance with some embodiments.

### DETAILED DESCRIPTION

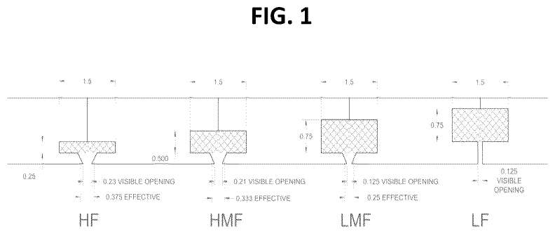

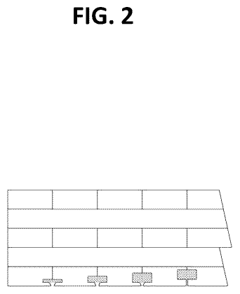

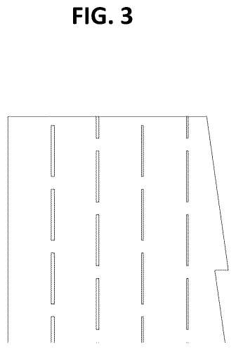

FIGS. 1-16 illustrate example configurations, structures, and processes to implement channels at the bottom ply of a CLT panel for use in a floor slab. A CLT panel involves stacking layers of lumber at right angles and bonding them together to create large, solid panels used for walls, floors, and roofs. Typically a variety of design considerations must be taken into account. In an example, structural viability necessitates the preservation of the strength of the CLT in both directions. This involves limiting material removal to just the last ply and minimizing disruption to glue joints to maintain structural integrity and stability. In another example, where acoustic performance is concerned, effective designs consider broad-band coverage across frequencies of interest while also allowing for tunability to suit specific applications. In yet another example, aesthetics play a role in design considerations, as the panel must be accepted by architects and owners. To achieve this, minimal deviation from the established look of CLT is essential, along with the incorporation of established patterns and profiles. Manufacturability is another important factor, requiring the minimization of the number of cuts and processes involved, as well as the utilization of standard machines and tooling to streamline production. By carefully considering these example design considerations, the CLT panel can effectively meet the requirements for acoustic performance, aesthetics, manufacturability, and structural viability, ensuring its suitability for use in floor slab applications.

FIGS. 1-3 illustrate an example CLT panel for use in a floor slab that implements one or more channels at a bottom ply in accordance with some embodiments. The channels are machined along the short face of each board constituting the bottom ply, aligned parallel to the grain axis for the entire length of the board. Upon assembly, these channels form rectangular chambers through the alignment of mirrored slots in adjacent boards. Furthermore, the edges of each board are sculpted with notches or chamfers at visible corners, creating periodic visible slots upon assembly. These slots are meticulously designed in terms of dimensions, frequency, and orientation to optimize both acoustic performance and visual appeal. By chamfering the slots, the “effective opening” is increased, thereby augmenting high-frequency performance which can be difficult to achieve with acoustic resonance absorption alone. The chambers are subsequently filled with strips of sound-absorbing, fire-resistant material, like mineral wool. The boards are then bonded, layered, and compressed using standard CLT manufacturing procedures. The periodic sections of intact wood between the visible slots facilitate lateral contact and adhesive bonding between adjacent boards. The chambers and slots function as acoustic resonators, further enhanced by the incorporation of sound-absorbing material.

In implementations, geometrically “tuned” resonators target specific resonant frequencies, forming a tuned resonator array during the customary assembly process of individual boards. The geometric parameters of this array are optimized to provide sound absorption across a spectrum of frequencies relevant to architectural acoustics and can be customized for specific project requirements. This modification aims to minimally impact the strength and stiffness of the CLT panel in its primary load-bearing direction, where the bottom ply experiences longitudinal loading. Shear strength is preserved by the horizontal adhesive bond at the top of the bottom ply and in the secondary load-bearing direction by the partially intact vertical edge adhesive bond. The initial concept involves determining the dimensions for various frequency ranges of resonators, including high-frequency (HF), high mid-frequency (HMF), low mid-frequency (LMF), and low-frequency (LF) resonators.

As noted, in at least one embodiment, implementations of a CLT panel include various types of resonators being strategically integrated to address different frequency ranges. High-frequency (HF) resonators are designed with wider necks and shorter depths, optimized to resonate at higher frequencies. These resonators are positioned to effectively absorb and attenuate high-frequency sound waves. For high mid-frequency (HMF) resonators, slightly deeper chambers are engineered to target frequencies within the mid-range of the audible spectrum. Positioned strategically, these resonators effectively absorb sound waves in the mid-frequency range. Low mid-frequency (LMF) resonators feature even deeper chambers, with narrower openings compared to HMF resonators. Tuned to address frequencies in the lower mid-range of the audible spectrum, these resonators contribute to comprehensive mid-frequency sound absorption. Finally, low-frequency (LF) resonators are designed with the largest chambers, and most narrow openings to capture and absorb low-frequency sound waves effectively. Placed strategically, LF resonators address frequencies at the lower end of the audible spectrum, ensuring balanced sound absorption across the relevant frequency range. By incorporating a combination of resonators optimized for different frequency bands, this CLT panel achieves efficient sound absorption capabilities, enhancing acoustic performance in architectural settings.

Further, in implementations, the slot resonator array involves fabricating boards or panels with precision to create a series of slots for resonator chambers. In the fabrication process, boards can be individually machined using a two-step process. First, a chamber cut is made along the full length of the board to create the resonator chambers. Then, periodic notches are made to create neck chamfers, optimizing the performance of the resonators. Alternatively, the entire panel can be machined using a T-slot router bit. However, this method has limitations including that all slots are full length, lacking the periodic neck chamfers, and being constrained by standard router bit dimensions. Despite these constraints, both methods aim to create an array of resonators within the CLT panel to enhance its acoustic performance.

A slot resonator is a type of acoustic device designed to absorb or attenuate sound waves within a specific frequency range. It consists of a slot or cavity cut into a surface, typically within a material such as wood or metal. When sound waves interact with the slot, they are partially absorbed, leading to a reduction in the magnitude of the reflected sound. Slot resonators are often used in architectural acoustics to improve the sound quality of indoor spaces by reducing reverberation, controlling echoes, and enhancing speech intelligibility. They can be tuned to target specific frequencies of interest, making them versatile tools for optimizing the acoustic environment in various settings such as events spaces, classrooms, and offices.

In implementations, the slot resonator array concept for CLT panels is influenced by the Helmholtz resonator theory, which dictates the relationship between a vibrating column of air in a “neck” and a volume of air in a “chamber”. In accordance with this theory, the concept creates a series of tuned resonators that effectively absorb sound waves across a broad frequency range relevant to architectural acoustics. By strategically positioning and dimensioning the resonator chambers, the concept maximizes their effectiveness in attenuating sound energy. Additionally, the Helmholtz acoustic resonator theory informs the design of the chambers themselves, ensuring optimal resonance and absorption of sound waves. Through the integration of these principles, the Slot Resonator Array Concept endeavors to enhance the acoustic properties of CLT panels, contributing to improved acoustic comfort, clarity, and speech intelligibility in architectural environments.

In some implementations, slot resonators carefully incorporate various geometric variables to refine acoustic performance. For instance, when adjusting slot width, an increase causes the resonant frequency to shift upwards within the spectrum. Additionally, wider slots result in a broader absorption range, transitioning from resonant to porous absorption. Similarly, slot spacing plays a crucial role; as it increases, the resonant frequency shifts downwards. Moreover, closely spaced slots, characterized by a larger percentage of openness, enhance broadband absorption and introduce coupling effects from nearby resonators. Neck depth is also an integral consideration; increasing it leads to a downward shift in the resonant frequency. Finally, cavity depth significantly impacts performance, with an increase causing a downward shift in the resonant frequency, ultimately optimizing the acoustic capabilities of slot resonators implemented in CLT panels for use in a floor slab.

In considering the structural implications of implementing slot resonators within a CLT panel, various factors come into play. Firstly, it's important to note that the bottom ply of the CLT panel typically experiences maximum normal stress at its outside face but lowest shear stress. Conversely, the shear stress is typically highest at the glue joint between the last and second-to-last ply. Notably, this specific joint remains unaffected by the modification introduced by the slot resonators. Understanding these stress distributions ensures the structural integrity and stability of the CLT panel, particularly under loading conditions involving moments and transversal forces. By analyzing these stress patterns, the slot resonators may be configured to enhance acoustic performance while maintaining the structural robustness of the CLT panel.

In some embodiments, the chambers within the slot resonators can be filled with various materials to achieve sound absorption and fire resistance. One common option is mineral wool, which is made from natural minerals like basalt or diabase. Mineral wool offers excellent sound-absorbing properties and is inherently fire-resistant, making it well-suited for this application. Additionally, fiberglass insulation is another commonly used material for filling the chambers. Fiberglass insulation is made from fine glass fibers and provides effective sound absorption while also being fire-resistant. Cellulose or wood fiber insulation, made from recycled or natural materials treated with fire-retardant chemicals, is another option that may offer a more environmentally friendly choice compared to mineral wool or fiberglass. These materials can be cut into strips or shapes to fit into the chambers of slot resonators.

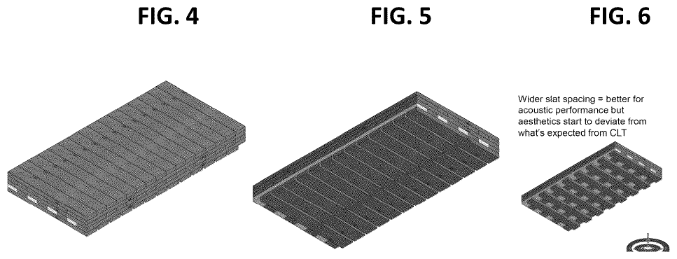

FIGS. 4-6 illustrate another example CLT panel for use in a floor slab that implements a slat design in accordance with some embodiments. In this embodiment for implementing slot resonators within a CLT panel, a slat design approach is utilized. Specifically, every other lamella in the second-to-bottom ply is omitted and the voids filled with non-combustible porous absorptive material, while the lamellas in the bottom ply are spaced to achieve single or varying gap widths. This design offers several advantages, including leveraging existing acoustic theory for slat absorbers/resonators, providing confidence in predicting performance outcomes. Additionally, the ability to adjust and vary the gap spacing allows for fine-tuning of the acoustic performance according to specific requirements. However, there are drawbacks to this approach, such as reduced strength in the direction of the voids due to the alternating lamella-void configuration. Additionally, there may be uncertainty regarding the degree to which the bottom two plies are compromised, raising structural integrity concerns. Furthermore, there's a risk of achieving narrow-band performance and limited speech frequency performance unless the openings are sufficiently large and varied. As the spacing of the slats widens to optimize acoustic performance, there's a trade-off with aesthetics, deviating from the expected appearance of traditional CLT panels. Thus, while this embodiment offers promising acoustic benefits, careful consideration of its structural and aesthetic implications is necessary for successful implementation.

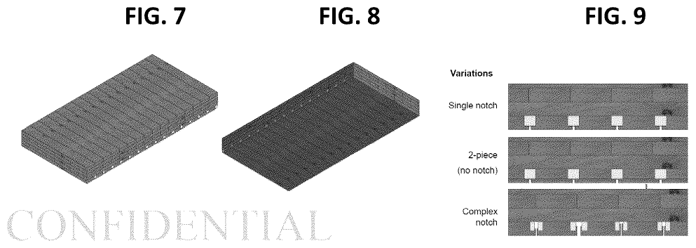

FIGS. 7-9 illustrate another example CLT panel for use in a floor slab that implements a notched lamella design in accordance with some embodiments. In this embodiment for implementing slot resonators within a CLT panel, the edges of each lamella are notched to form chambers and necks. This design introduces several advantages, including the ability to create resonator “necks” shorter than the lamella depth, which extends performance to higher speech frequencies. Additionally, it allows for a high degree of parameterization and variation, enabling fine-tuning of acoustic performance by adjusting parameters such as chamber volume, neck depth, and neck width. However, there are challenges associated with manufacturing complexity, as implementing notches in each lamella requires precision and attention to detail. Variations of this approach may include a single notch design, a two-piece configuration with no notch, and a more complex notch design, each offering different trade-offs in terms of acoustic performance and manufacturing feasibility. Despite these challenges, this embodiment offers potential for achieving tailored acoustic performance within CLT panels through precise parameterization and variation of notch designs.

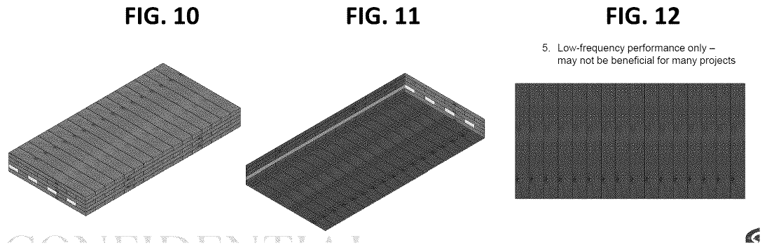

FIGS. 10-12 illustrate another example CLT panel for use in a floor slab that implements a perforated lamella design in accordance with some embodiments. In this embodiment for implementing slot resonators within a CLT panel, known as the perforated lamella design, every other lamella in the second-to-bottom ply is omitted and the voids filled with absorptive material. The lamellas in the bottom ply are then milled or drilled through to allow airflow, facilitating Helmholtz resonator absorption. This approach offers several advantages, including the utilization of existing acoustic theory for perforated absorbers/resonators, drawing from precedents in applications like radio studios. Furthermore, it provides flexibility to adjust and vary hole size and spacing to fine-tune acoustic performance according to specific requirements. Additionally, this implementation minimizes visual impact compared to standard CLT panels, particularly if the holes are relatively small. However, there are drawbacks to consider, including potential unequal strength in two directions due to alternating lamella-void configuration and manufacturing complexity associated with creating perforations. Moreover, there may be limited adjustability in resonator parameters such as neck length and cavity depth, potentially necessitating the division of the absorptive cavity into individual chambers to achieve resonance absorption. Lastly, this design may primarily benefit low-frequency performance, potentially limiting its applicability in projects requiring broader acoustic enhancements.

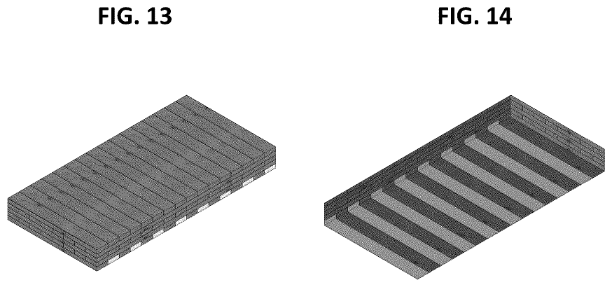

FIGS. 13 and 14 illustrate another example CLT panel for use in a floor slab that implements an every other lamella design in accordance with some embodiments. In this embodiment for implementing slot resonators within a CLT panel, a straightforward approach involves replacing every other lamella in the bottom layer with sound-absorbing material, which is left exposed to the room. This design offers certain advantages, notably that only the bottom ply is affected, simplifying the implementation process. Additionally, the fully exposed absorptive material provides acoustic benefits across a wide frequency range. However, there are drawbacks to consider, including reduced strength from the bottom ply due to the alternating lamella configuration.

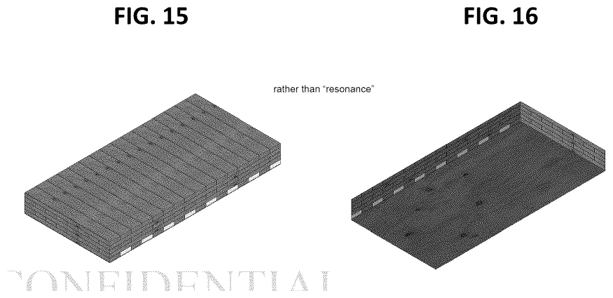

FIGS. 15 and 16 illustrate another example CLT panel for use in a floor slab that implements a perforated veneer in accordance with some embodiments. In this embodiment for implementing slot resonators within a CLT panel, known as Perforated Veneer design, every other lamella in the bottom ply is omitted, and the voids are filled with absorptive material, while a finely perforated veneer is applied to the bottom to conceal the absorption and provide a wood aesthetic. The perforations in the veneer may take the form of holes or slots that are minimally visible when viewed from a distance. This approach offers several advantages, including the visual concealment of the absorptive material by the veneer, ensuring a cohesive wood aesthetic. Additionally, the thin perforated facing allows for acoustic performance extension to speech frequencies, leveraging existing acoustic theory for perforated absorbers/resonators and providing confidence in performance predictions. However, there are drawbacks to consider, including reduced strength in the direction of the voids due to the alternating lamella configuration. Furthermore, the addition of a veneer incurs extra expenses, and sourcing veneer from a separate specialist manufacturer may pose logistical challenges. Additionally, the use of veneer for aesthetic purposes only may raise sustainability concerns compared to other options.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A cross-laminated timber (CLT) panel, comprising:
a first ply with one or more acoustic resonators comprising;
a channel retaining a material;
an opening; and
the one or more acoustic resonators are designed to be tuned to a frequency range relevant to architectural acoustics and are formed through a standard lay-up and gluing process of individual lamellas forming a bottom ply of the CLT panel.

2. The CLT panel of claim 1 wherein the first ply is a bottom ply.

3. The CLT panel of claim 1 further comprising:
a second ply disposed at a perpendicular orientation in relation to the first ply.

4. The CLT panel of claim 3 further comprising:
the second ply to overlay a first surface of the first ply.

5. The CLT panel of claim 1 wherein the one or more acoustic resonators include at least one of a high-frequency (HF), a high mid-frequency (HMF), a low mid-frequency (LMF), or a low-frequency (LF).

6. The CLT panel of claim 1 wherein the material is sound absorbing.

7. The CLT panel of claim 1 wherein the material is a fire resistant material.

8. The CLT panel of claim 1 further comprising:
a notched edge bordering the opening.

9. The CLT panel of claim 8 wherein the notched edge is tapered.
